(19) United States
(12) Patent Application Publication
(10) Pub. No.: US 2018/0068352 A1
(43) Pub. Date: Mar. 8, 2018

(54) VISIBLE ADVERTISING SYSTEM, ADVERTISING METHOD AND ADVERTISEMENT DISPLAYING METHOD

(71) Applicant: Viscovery (Cayman) Holding Company Limited, Grand Cayman (KY)

(72) Inventors: Chun-Chieh HUANG, Taipei City (TW); Shao-Hang HSIEH, Taipei City (TW)

(21) Appl. No.: 15/452,512

(22) Filed: Mar. 7, 2017

(30) Foreign Application Priority Data
Sep. 6, 2016 (TW) 105128739

(51) Int. Cl. G06Q 30/02; G06F 17/30

(52) U.S. Cl. CPC G06Q 30/0275; G06F 17/30823

(57) ABSTRACT

A visible advertising system includes steps of: receiving a searching keyword; searching for videos according to the searching keyword in order to obtain multiple frames of the searched videos which include a target corresponding to the searching keyword; analyzing the multiple frames in order to filter more than one worth-to-advertise advertising points; selecting one of the advertising points for advertising an advertisement; setting a content of the advertisement and audience conditions for a target audience of the advertisement; bidding for the selected advertising point after being triggered; and assigning the advertisement to the selected advertising point once the bidding is wining.

### BACKGROUND OF THE INVENTION

### 1. Technical Field

The technical field relates to an advertising system, and in particular relates to a visible advertising system, advertising method, and an advertisement displaying method adopted by the visible advertising system.

### 2. Description of Prior Art

Advertisements have always been the best way to attract consumers to consume or to engage in specific activities. However, as advertising is expensive, advertisers want to know how to advertise more effectively in order to obtain maximum advertising benefit.

With the development of the Internet, the advertising market on the Internet has also been growing, and has become very competitive, similar to the real world. Additionally, following the maturity of the network transmitting technology, network advertisements have transformed from flat webpages into network videos.

The most popular advertising type in the current market is the pre-movie advertisement. In particular, after a video website is requested by the user for a video, the video website plays an advertisement to the user in advance, and then plays the requested video after the advertisement ends. Therefore, it is assured that all users watching the video can see the advertisement, so as to improve the awareness of the advertisement.

The aforementioned pre-movie advertisement depends on the advertising right of the video. For example, the advertiser can directly buy the advertising right of the video, otherwise, the advertiser needs to win a bid for the advertising right of the video through a real-time bidding (RTB) system. Once the advertiser obtains the advertising right of the video, he or she is assured that all users requesting the video website to play the video will see the advertisement provided by the advertiser. However, there is no relativity between the content of the advertisement and the content of the video, so the advertisement seems unexpected and even odd to the users. Moreover, the users are forced to watch the advertisement before the video is displayed, so the users are usually annoyed with the advertisement.

Additionally, when obtaining the advertising right of the video, the advertiser has no way to know who will watch the video. That is to say, the advertiser cannot know who will be the audience of the advertisement. Therefore, the benefit of the advertisement cannot be assured, and the advertising resources of the video could be wasted (for example, the video has a huge amount of audiences, but 90% of the audiences are not potential consumer of the product corresponding to the advertisement).

Besides the aforementioned pre-movie advertisement, the current market also provides other advertising platforms which collaborate with a Data Management Plarform (DMP). In particular, the DMP can analyze and guess users' information, such as identity, interest, habit, etc., according to browsing data of the users (for example, cookies from browsers), and the DMP provides the information to multiple advertisers for bidding. That is to say, the advertisers are not bidding for the videos, but for the users.

The aforementioned advertising platform allows the advertiser to advertise the advertisement to specific users. Once the users are targeted, they receive the same advertisement from the same advertiser no matter what they intend to watch accordingly. Although the aforementioned advertising method can make sure the users who will see the advertisement are the target audience of the advertisement, the content of the advertisements are still unrelated with the content of what the users found through the internet. As a result, the advertisement is still unexpected and even odd to the users, and the advertising benefit is hard to be improved.

### SUMMARY OF THE INVENTION

The present invention is to provide a visible advertising system, visible advertising method and advertisement displaying method, which can search for multiple advertising points which comprise a target and are worth-to-advertise from a video according to requirements of an advertiser, and can set content of an advertisement and an audience condition of a target audience upon the advertising points, so as to create high relativities among the video content, video audience and advertisement content.

Accordingly, the present invention comprises following steps of: receiving a searching keyword; searching for videos according to the searching keyword in order to obtain multiple frames of the searched videos which comprise a target corresponding to the searching keyword; analyzing the multiple frames in order to filter more than one worth-to-advertise advertising point; selecting one of the advertising points for an advertisement; setting a content of the advertisement and an audience condition for a target audience of the advertisement; bidding for the selected advertising point after being triggered; and, assigning the advertisement to the selected advertising point once the bidding is wining.

Compared with prior art, the present invention allows the advertiser to see the frames which comprise the target and are worth-to-advertise of the video in advance, so the advertiser can decide whether to advertise the advertisement on one of the frames. Also, the advertiser can set the content of the advertisement and the target audience of the advertisement when performing the advertising, so the relativities among the advertisement content, the video content and the video audience are highly assured. Therefore, the advertising benefit is effectively improved, and the advertisement content will be acceptable to the video audience.

### BRIEF DESCRIPTION OF THE DRAWINGS

FIG. 1 is a system schematic diagram of a first embodiment according to the present invention.

FIG. 2 is a first schematic diagram of an advertising platform of a first embodiment according to the present invention.

FIG. 3 is a second schematic diagram of the advertising platform of the first embodiment according to the present invention.

FIG. 4 is a third schematic diagram of the advertising platform of the first embodiment according to the present invention.

FIG. 5 is a fourth schematic diagram of the advertising platform of the first embodiment according to the present invention.

FIG. 6 is a fifth schematic diagram of the advertising platform of the first embodiment according to the present invention.

FIG. 7 is a flowchart of video analyzing of a first embodiment according to the present invention.

FIG. 8 is a flowchart of advertisement advertising of a first embodiment according to the present invention.

FIG. 9 is a flowchart of advertisement displaying of a first embodiment according to the present invention.

### DETAILED DESCRIPTION OF THE INVENTION

In cooperation with the attached drawings, the technical contents and detailed description of the present invention are described thereinafter according to a preferable embodiment, being not used to limit its executing scope. Any equivalent variation and modification made according to appended claims is all covered by the claims claimed by the present invention.

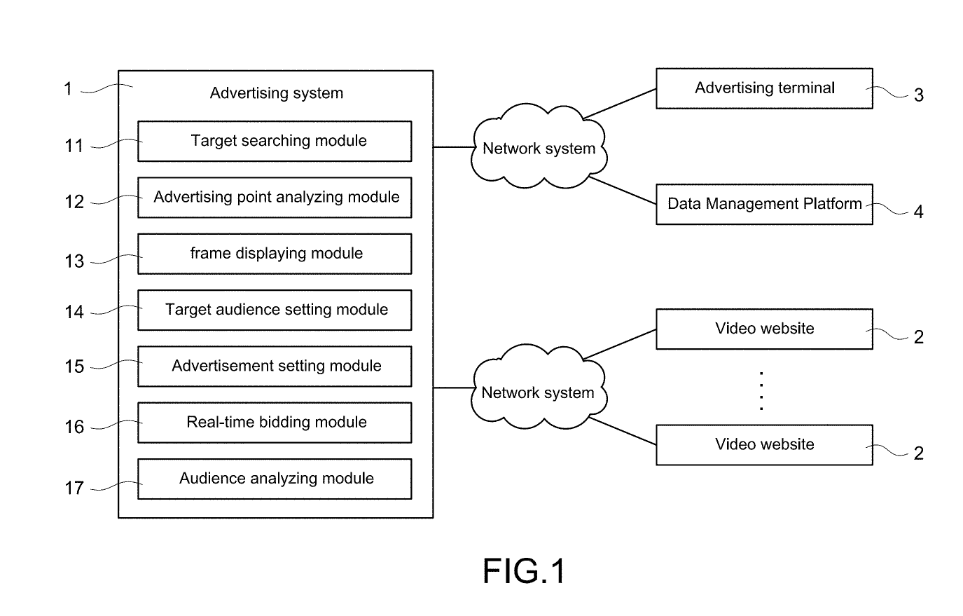

FIG. 1 is a system schematic diagram of a first embodiment according to the present invention. The present invention discloses a visible advertising system 1 (referred to as the system 1 hereinafter), the system 1 is built on the Internet and operates an advertising platform thereon (not shown), so as to provide advertisers to search for desire video frames for advertising.

As shown in FIG. 1, the system 1 connects to one or more video websites 2, such as Youtube.com, iQIYI.com, Youku.com, etc., through a network system. The system 1 also performs analysis to multiple videos stored in the video websites 2, so as to identify and label for different targets existing in each of the videos. Therefore, when using the system 1, an advertiser can directly search for desired frames which comprise a specific target, and then consider whether to advertise a corresponding advertisement on these frames or not. The system 1 in this embodiment mainly analyzes the multiple videos in these video websites 2 connected therewith. In other embodiments, the system 1 can also analyze multiple videos stored in its own database (not shown), and doesn't need to connect with the external video websites 2.

In particular, as shown in FIG. 1, an advertiser can remotely operate an advertising terminal 3, login into the advertising platform operated by the system 1 through the advertising terminal 3, search for desired video frames upon the advertising platform, and perform advertising for a corresponding advertisement.

In this embodiment, the system 1 comprises a target searching module 11, an advertising point analyzing module 12, a frame displaying module 13, a target audience setting module 14, an advertisement setting module 15 and a real-time bidding (RTB) module 16. In the present invention, the modules 11-16 of the system 1 are implemented by software, and the advertising platform executes the software to perform corresponding functions of the aforementioned modules 11-16. The specific function of each of the modules 11-16 is detailed described as following.

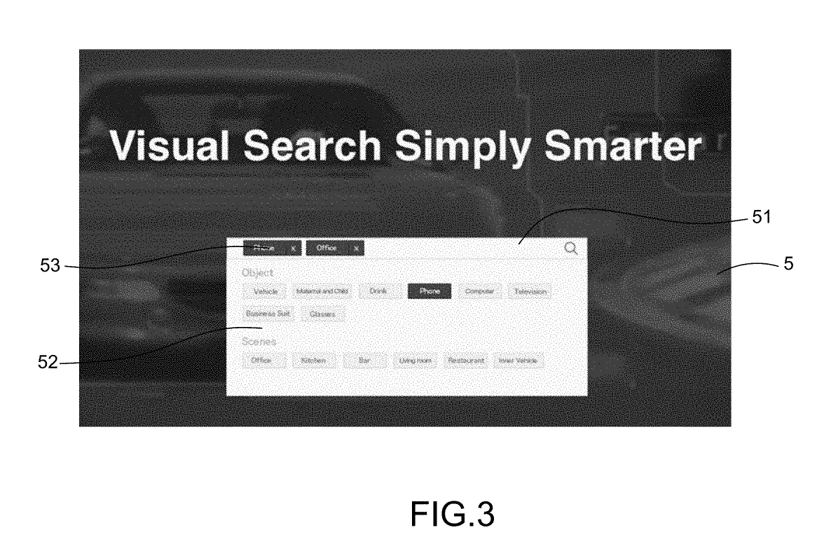

The target searching module 11 can receive an input of a searching keyword from the advertising terminal 3 (such as the searching keyword 53 shown in FIG. 3), and perform searching on a plurality of analyzed videos in the video websites 2 according to the searching keyword 53. Therefore, it can then obtain multiple frames from one or more of the videos which comprise a target, wherein the searching keyword 53 is corresponding to a label of the target. For example, if the advertising terminal 3 inputs “cell phone” as the searching keyword 53, the target searching module 11 will list, after searching, multiple frames from the videos which comprise a cell phone. For the purpose of illustration, the following examples will be described in searching one single video.

In this embodiment, the label records the name (such as cell phone) and type of the target, and the label can also record at least one of appearance location, appearance time, appearance time duration, frame proportion, etc., of the target in the video, and the searching keyword 53 is typically corresponding to the name of the target. In this embodiment, the type recorded in the label comprises an object type and a scene type, but not limited thereto.

The advertising point analyzing module 12 performs analysis to the multiple frames searched by the target searching module 11, in order to filter multiple specific frames which are worth-to-advertise, and takes these specific frames as multiple advertising points to be used by the advertiser. In this embodiment, an amount of the multiple advertising points is less than that of the multiple frames.

In particular, the target searching module 11 compares the searching keyword 53 with multiple labels of the videos, and lists multiple frames which are compared successfully, so as to make sure the target corresponding to the searching keyword 53 does exist in the listed frames. However, according to the inventor's practical experiment, a one-hour-length video will identify about 2000 frames of a specific target. If all the identified frames of the video are provided to the advertiser to perform advertising, the video will be full of the advertisements, affecting the quality of the video and users' enjoyment.

Besides, many of the listed frames are unimportant scenes, which are not worth-to-advertise. Accordingly, the present invention performs further analysis for the multiple listed frames through the advertising point analyzing module 12, so as to filter the advertising points which are worth-to-advertise. In one of the exemplary embodiments, the amount of the advertising points is less than ten. Therefore, the amount of the advertisements appeared in the video is well controlled, so as to reduce the effect from the advertisements to the video, and the advertising value can be raised because all the advertising points are important frames of the video, so as to make profits to the system 1.

In one of the exemplary embodiments, the advertising point analyzing module 12 analyzes whether each of the frames is the worth-to-advertise specific frame according to at least one of the information of each frame, such as background music information (e.g., theme song, soundtrack, dancing music, lyric music, name of vocal, etc.), background lighting atmosphere (e.g., morning, night, sunny day, raining day, light intensity, etc.), appearance of leading role (e.g., leading man exists, leading lady exists, popular supporting role exists, etc.), appearance time of the target, etc. In this embodiment, the system 1 can analyze the videos in advance in order to obtain the aforementioned information and records it in the label. Otherwise, the system 1 can perform real-time analysis in order to obtain the information after receiving the searching keyword 53, not limited thereto.

More specifically, the advertising point analyzing module 12 can be regarded as an artificial intelligence (AI) system of the system 1, and the advertising point analyzing module 12 is trained in advance by machine learning. As a result, the advertising point analyzing module 12 can perform analysis and generalization automatically according to the aforementioned information, so as to determine whether each of the frames is worth-to-advertise or not.

The advertisement setting module 15 receives an operation from the advertising terminal 3 after the advertising points are listed, so as to select one of the advertising points and upload an advertisement upon the selected advertising point, and also sets advertising budget of the uploaded advertisement.

Moreover, after one of the advertising points is selected by the advertising terminal 3, the frame displaying module 13 directly displays the frame corresponding to the selected advertising point on the advertising platform (it can be a single frame or a fragment). Through the frame displaying module 13, the advertiser can directly see the frame corresponding to the selected advertising point on the advertising platform, so as to determine whether to advertise the advertisement on the advertising point. Therefore, the purpose of “visible” advertising of the present invention is achieved.

After the advertiser uploads the advertisement, the target audience setting module 14 can receive an audience condition for a target audience of the advertisement set by the advertising terminal 3. In this embodiment, the audience condition at least comprises age and gender of the target audience, but is not limited thereto. According to the setting of the audience condition, if the user who's watching the video on the video website 2 is unsatisfied with the audience condition, the system 1 won't display the advertisement even if the video is displayed to the advertising point. Therefore, the users who are not the target audience are prevented from watching the advertisement forcibly, so the unnecessary advertising cost is saved.

The system 1 also comprises an audience analyzing module 17. The audience analyzing module 17 analyzes a potential audience of the selected advertising point, i.e., to analyze who (taking users' age proportion and gender proportion into account) will see the selected advertising point in the video. Therefore, it can provide other information to the advertiser, and the advertiser can consider whether to advertise the advertisement on the advertising point or not according to the above information (i.e., the analyzed potential audience). For example, if the advertiser represents a sports car manufacturer, and though the click rate of the video is very high, but the average age of the users of watching the video is too low (for example, eight to twelve), then the advertiser is unwise to advertise its advertisement on the advertising point in the video.

According to the aforementioned description, the advertiser who uses the system 1 does not need to search for popular videos and negotiate for the advertising right of the videos. The advertiser only needs to perform inquiry on the advertising platform operated by the system 1, and advertises the advertisement on each interesting advertising point, which is very convenient. In other words, the advertising platform operated by the system 1 of the present invention is actually a demand-side platform (DSP) for the videos.

The RTB module 16 receives the operation of the advertising terminal 3 to confirm advertising the advertisement on the advertising point. After the advertising is confirmed by the advertiser, the RTB module 16 bids for the advertising point according to the advertising budget of the advertisement, and assigns the advertisement to the advertising point once the bidding is winning.

In the present invention, the same advertising point can accept different advertising requests from different advertisers, and only one of the advertisers who has the highest advertising budget will obtain the advertising right of the advertising point. That is to say, the system 1 of the present invention can implement a real-time bidding (RTB) function at the same time, and the bidding target is each worth-to-advertise frame in the video, not the entire video itself.

It should be mentioned what the system 1 of the present invention provides to the advertiser is to bid for one advertising point by one advertising budget, so the advertiser can upload multiple advertisements upon same advertising point, and sets different audience conditions for each of the advertisements. Therefore, if the advertiser wins the bid and obtains the advertising right of the advertising point, different users may see different advertisements when watching the video to be displayed to the advertising point (for example, the advertiser represents a laptop computer manufacturer, then male users will see an advertisement for gaming laptop computers at the advertising point, and female users will see other advertisement for business laptop computers at the same advertising point).

As shown in FIG. 1, the system 1 in the present invention further connects to a data management platform (DMP) 4 through the network system. Therefore, when a user logins into the video website to watch the video and the video is displayed to the advertising point, the system 1 can obtain relative information of the user (such as demography, interest, behavior, etc.) from the DMP 4, and determine if the user satisfies the audience condition of the advertisement on the advertising point according to the relative information, so as to decide whether to display the advertisement or not. In other words, the system 1 can make sure that all users who can see the advertisement are the target audience of the advertisement, so as to save unnecessary advertising cost.

It should be mentioned that the DMP 4 can be embedded in the system 1, and the system 1 gathers the relative information of network users to perform analysis all by itself. Therefore, the platform operated by the system 1 is actually a powerful platform integrated with content identification, RTB, DSP and DMP. The DMP 4 belongs to prior art of the technical field, no more discussion is needed here.

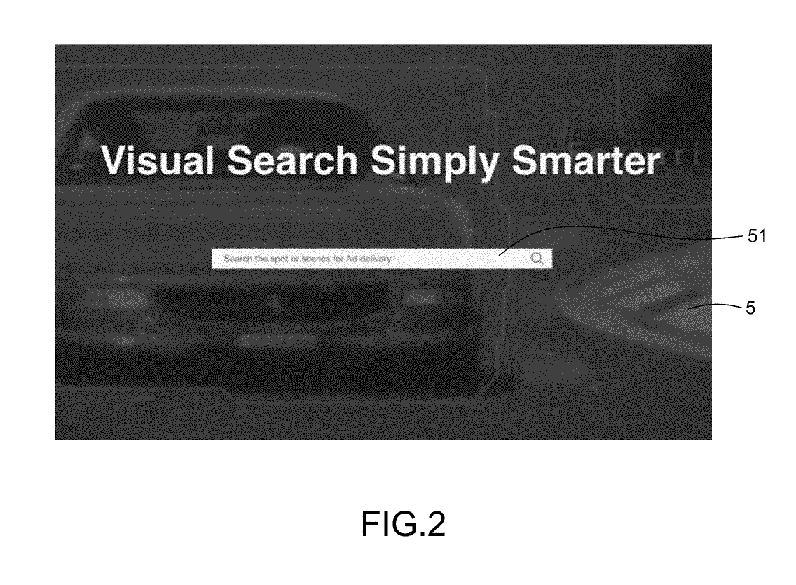

FIG. 2 to FIG. 6 are the first to fifth schematic diagrams of an advertising platform of a first embodiment according to the present invention. Referring to FIG. 2, the system 1 in the present invention provides a searching page 5 on the advertising platform, and the target searching module 11 provides a searching column 51 on the searching page 5. When intending to search for the advertising point, the advertiser can operate the advertising terminal 3 to input the searching keyword 53 in the searching column 51.

Referring to FIG. 3, in this embodiment, the target searching module 11 also provides a keyword recommending option 52 on the searching page 5. The keyword recommending option 52 comprises keywords recommended by the system 1 or names of different targets which are already analyzed and labeled of the videos. In the embodiment in FIG. 3, the keyword recommending option 52 includes different names of the object type, such as “car”, “baby”, “beverage”, “cell phone”, “computer”, “television”, “suit”, “glasses”, etc., and different scenes of the scene type, such as “office”, “kitchen”, “bar”, “living room”, “restaurant”, “inside of car”, etc. In this embodiment, the advertiser doesn't need to input the searching keyword 53 by his or her own hand, he or she can instead select one or more keywords on the keyword recommending option 52, and the system 1 will use the selected one or more keywords as the searching keyword 53 and inputs it to the searching column 51. Therefore, the system 1 prevents unprecise searching results due to wrong keyword(s) manually input by the advertiser

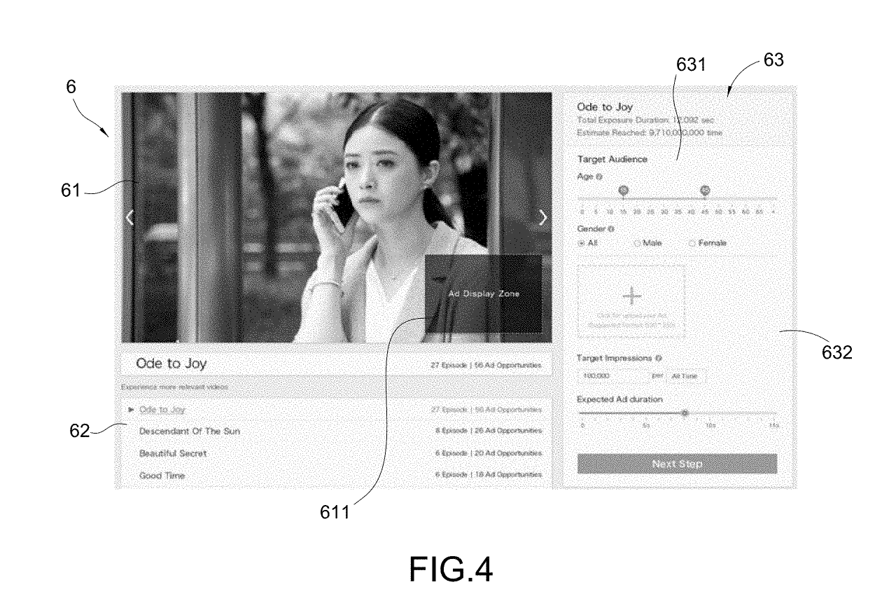

Referring to FIG. 4, the system 1 further provides an advertising page 6 on the advertising platform. As shown in FIG. 4, the advertising page 6 comprises a frame displaying column 61 provided by the frame displaying module 13, an advertising point listing column 62 provided by the advertising point analyzing module 12, an audience setting column 631 provided by the target audience setting module 14 and an advertisement setting column 632 provided by the advertisement setting module 15.

In particular, after searching for the frames according to the searching keyword 53, the target searching module 11 provides all the found frames to the advertising point analyzing module 12. The advertising point analyzing module 12 then performs analysis to the frames respectively, and displays multiple worth-to-advertise advertising points on the advertising point listing column 62 for the advertiser to view and to select. In the embodiment in FIG. 4, the advertising point listing column 62 displays title, episode, and amount for advertising (i.e., the amount of the advertising point) of the multiple videos which are regarded as worth-to-advertise by the advertising point analyzing module 12, but not limited thereto.

Once the advertiser selects one of the advertising points displayed on the advertising point listing column 62, the frame corresponding to the selected advertising point will be displayed on the frame displaying column 61. Therefore, the advertiser can directly see the appearance of the advertising point.

In the embodiment, the frame displaying column 61 and the advertising point listing column 62 are located on the left side of the advertising page 6, and the advertising page 6 further comprises a setting column 63 on right side. In particular, the setting column 63 at least comprises the audience setting column 631 and the advertisement setting column 632.

After selecting one of the advertising points, the advertiser can further operate the advertising terminal 3 to set the audience condition of the target audience on the audience setting column 631 (in FIG. 4, the audience condition is age and gender for example, but not limited). Also, the advertiser can upload the advertisement through the advertisement setting column 632, and set parameters for the uploaded advertisement, such as target awareness, length of time, etc. The advertisement in this embodiment can be a static image advertisement or a dynamic video advertisement.

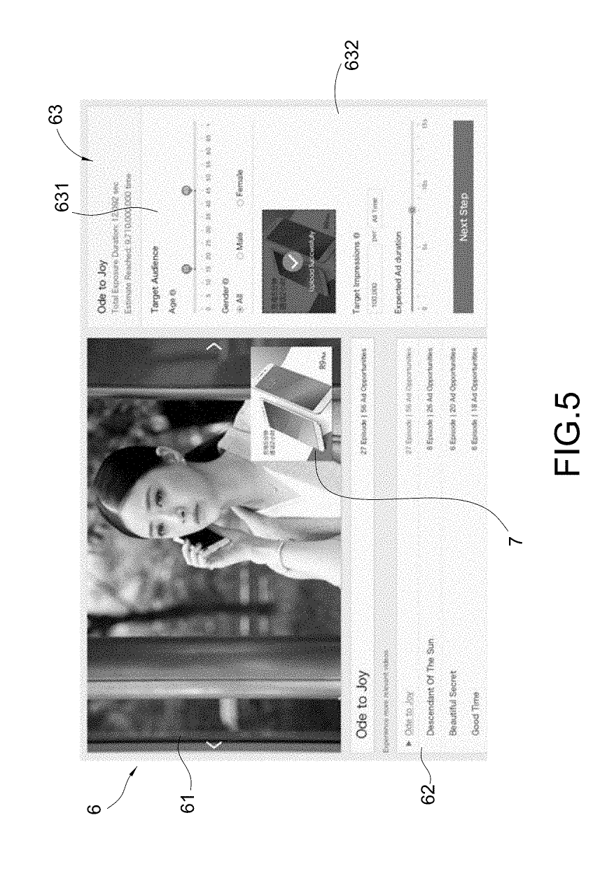

Referring to FIG. 5, the frame displaying module 13 further configures an advertisement displaying area 611 on the frame displaying column 61. After the advertiser uploads the advertisement, the advertising page 6 can directly display an uploaded advertisement 7 on the advertisement displaying area 611. Therefore, the advertiser can see the appearance of the uploaded advertisement 7 on the selected advertising point upon the frame displaying column 61 and the advertisement displaying area 611, so as to achieve the goal of “visible” advertising of the present invention

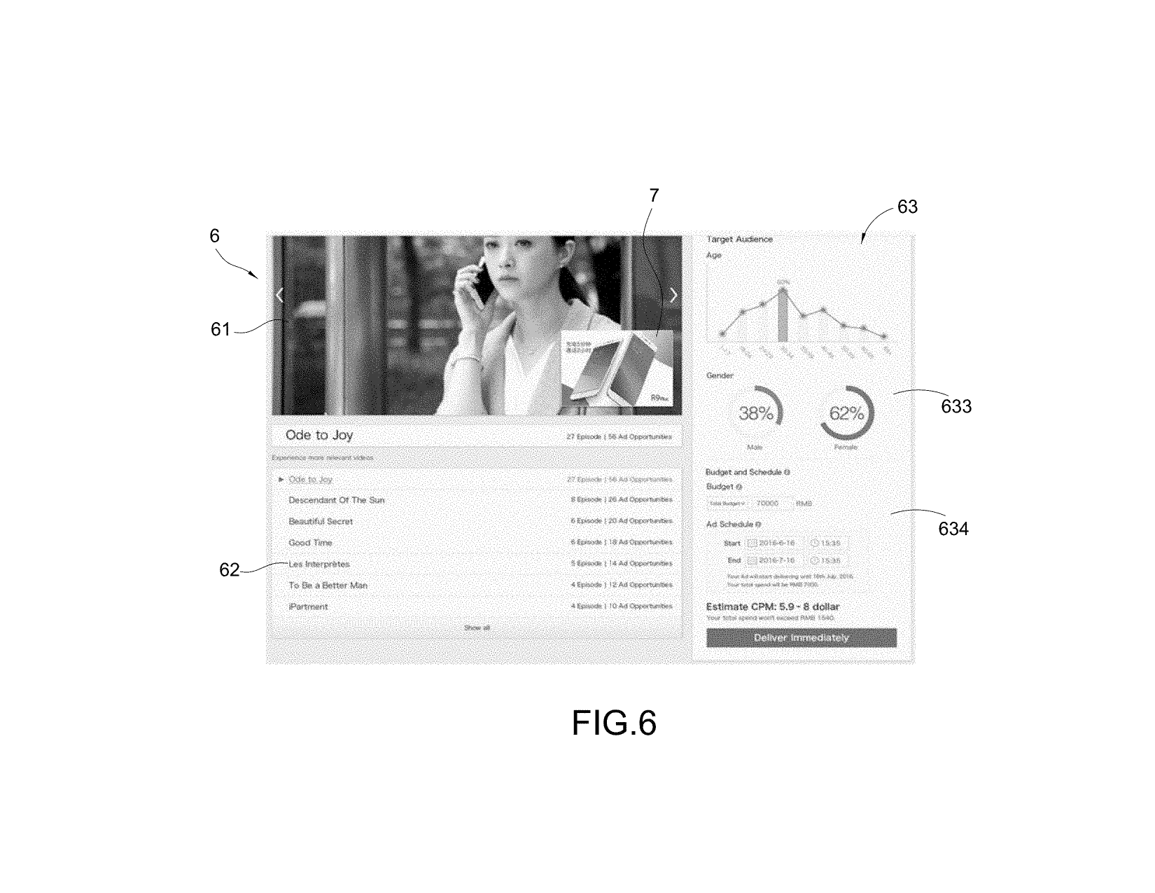

Referring to FIG. 6, the setting column 63 further comprises an audience analyzing column 633 and a bidding column 634. The audience analyzing column 633 displays the potential audience (such as age proportion and gender proportion) of the advertising point (or the video having the advertising point). Also, the advertiser can set the advertising budget and an advertising schedule (for example, a starting time and an ending time of the advertising) of the advertisement through the bidding column 634.

In this embodiment, the RTB module 16 calculates Cost per Mille (CPM) of the advertisement according to the advertising budget, the length of time and the advertising schedule, and displays the CPM on the bidding column 634. Therefore, the advertiser can determine whether to advertise the advertisement or not on the advertising point, or to reconsider if the budget is enough. When an “Advertising Now” button on the setting column 63 is triggered, it means the advertiser wants to advertise the advertisement, so the RTB module 16 performs a bidding action for bidding the selected advertising point immediately according to the advertising budget.

By using the present invention, the advertiser only needs to input or select the desired searching keyword 53 (the searching keyword 53 is typically related to the advertisement to be advertised by the advertiser), and the advertising platform will find appropriate video(s) and appropriate frames of the video(s) for advertising the advertisement. Also, the advertising platform will analyze and provide the age proportion and the gender proportion of the potential audience of the appropriate frames, so as to assist the advertiser to decide whether to advertise the advertisement on each of the appropriate frames or not, which is very convenient.

When searching the aforementioned frames, the system 1 compares the searching keyword 53 input or selected by the advertiser with the labels of the multiple videos in the video websites 2. To do so, the videos indicated in the present invention need to be analyzed, identified and labeled in advance.

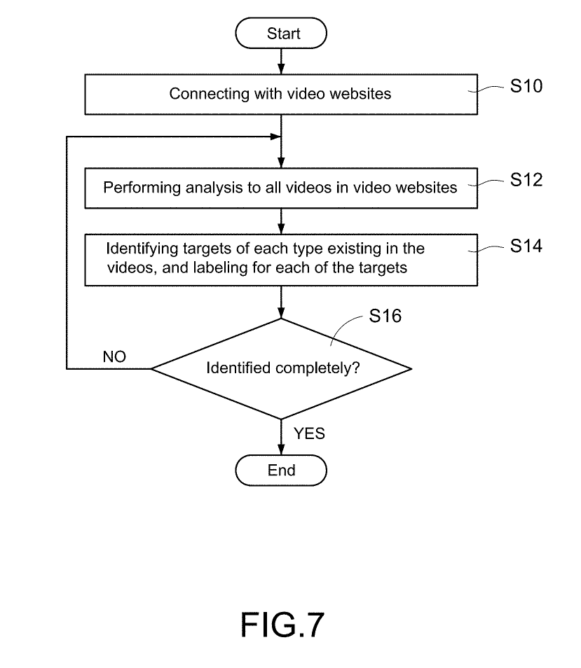

FIG. 7 is a flowchart of video analyzing of a first embodiment according to the present invention. For implementing the system 1 of the present invention, the system 1 needs to be connected with each of the video websites 2 (step S10) to perform analysis to all videos in each of the video websites 2 (step S12). In particular, the system 1 executes a video identification means to analyze the videos in the video websites 2, so as to identify targets of each type existing in the videos, and labels for each of the targets (step S14).

Specifically, the system 1 identifies name (such as car, cell phone, kitchen) and type (such as object type or scene type) of the targets, and information of the targets in each of the videos such as appearance location, appearance time, appearance time duration, frame proportion, etc., and respectively records the name, the type and the information of the targets in the labels, so as to provide the system 1 to perform searching according to the searching keyword 53 afterward.

After the step S14, the system 1 determines if all videos are identified completely (step S16), and re-executes the step S12 to the step S14 before all videos are identified completely, so as to label all identified targets of all videos, and to improve the searching accuracy of the system 1.

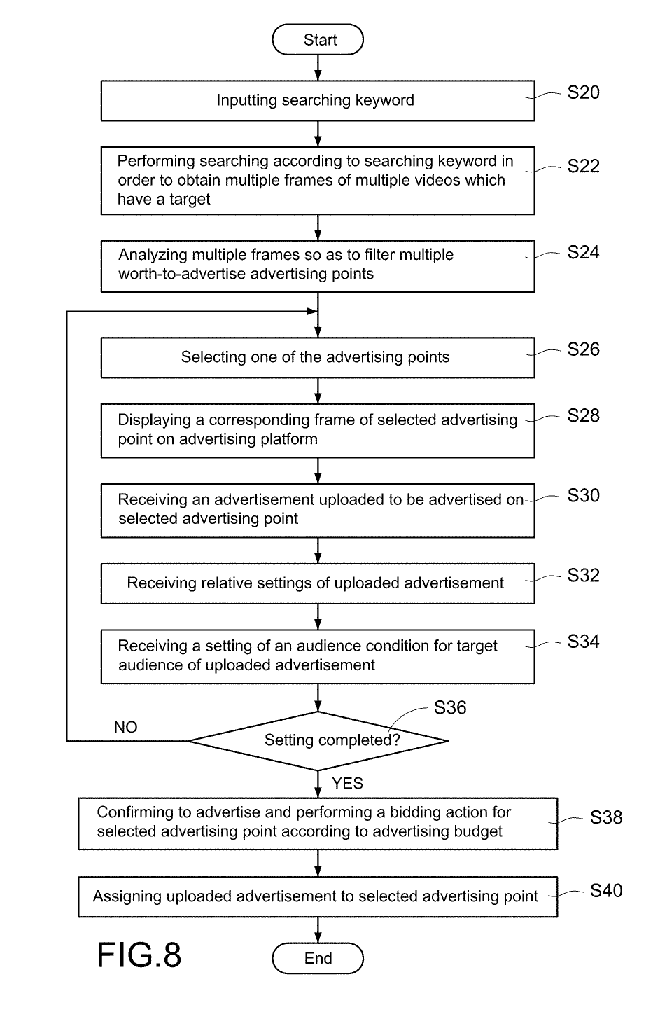

FIG. 8 is a flowchart of advertisement advertising of a first embodiment according to the present invention. The present invention further discloses a visible advertising method (referred to as the method hereinafter), the method is operated by the system 1 disclosed in FIG. 1.

First, the system 1 receives, upon the advertising platform, the searching keyword 53 input from the advertising terminal 3 (step S20), and performs searching according to the searching keyword 53 in order to obtain multiple frames of multiple videos which have a target (step S22), wherein the searching keyword 53 is corresponding to a label of the target. More specifically, the searching keyword 53 is the same as the name of the label of the target.

Next, the system 1 analyzes the multiple frames of the multiple videos respectively according to the aforementioned condition, so as to filter multiple specific frames which are worth-to-advertise, and respectively regards the specific frames as multiple advertising points (step S24). In this embodiment, an amount of the multiple advertising points is less than that of the multiple searched frames. In a preferred embodiment, the amount of the advertising points is less than ten, but not limited thereto.

After the step S24, the system 1 receives a selection from the advertising terminal 3 to select one of the advertising points of a specific video (step S26), and the system 1 then displays a corresponding frame of the selected advertising point on the advertising platform (step S28). In particular, the system 1 displays the corresponding frame on the frame displaying column 61 in the advertising page 6 of the advertising platform. Next, the system 1 receives an advertisement to be advertised on the selected advertising point uploaded from the advertising terminal 3 (step S30), and receives relative settings of the advertisement (step S32). In this embodiment, the relative settings of the advertisement comprise an advertising budget, a length of time and an advertising schedule of the advertisement, but not limited thereof.

It should be mentioned that after the advertising terminal 3 uploads the advertisement, the system 1 displays the uploaded advertisement directly on the corresponding frame displayed in the step S28, and the advertiser can see the appearance of the uploaded advertisement on the selected advertising point. In particular, the system 1 displays the uploaded advertisement on the advertisement displaying area 611 of the frame displaying column 61.

After step S32, the system 1 further receives a setting of an audience condition for a target audience of the advertisement (step S34). In particular, step S34 is to set the age and the gender of the target audience, but not limited. Next, the system 1 determines if the setting is completed or not (step S36), and re-executes the step S26 to the step S34 before the setting is completed (for example, the advertiser can set different audience conditions for different advertisements which are uploaded on the same advertising point).

After step S36, the system 1 further displays, on the advertising platform, a potential audience of the selected advertising point, such as age proportion and gender proportion of the potential audience of the video, so as to provide a reference to the advertiser to adjust the audience condition. More specifically, the potential audience is obtained from a result after the system 1 performs a cross calculation according to statistics data of the video websites 2 and the DMP 4. Also, after step S36, the system 1 can further display CPM of the advertisement calculated by the system 1 according to the advertising budget, the length of time, and the advertising schedule on the advertising platform, so as to assist the advertiser to confirm the advertising.

The system 1 then accepts a trigger from the advertising terminal 3 to confirm advertising for the advertisement, and performs a bidding action for the selected advertising point according to the advertising budget (step S38). Once the bidding action wins, the system 1 assigns the advertisement to the selected advertising point (step S40). Therefore, when watching the video on the video websites 2, the users can see the advertisement which is advertised by the advertiser on the advertising point in the video.

In order to determine whether the advertisement needs to be displayed when different users are watching the video on the video websites, so as to avoid wasting unnecessary advertising cost, the present invention further discloses an advertisement displaying method, which is operated by the system 1 shown in FIG. 1.

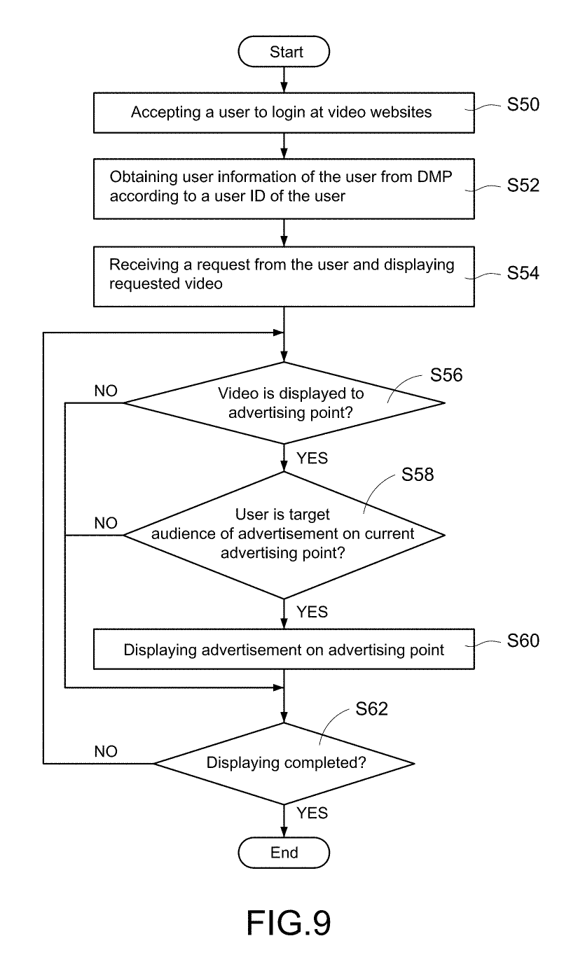

FIG. 9 is a flowchart of advertisement displaying of a first embodiment according to the present invention. In particular, the advertisement displaying method first accepts a user to login at any of the video websites 2 (step S50). The login indicated here means the user operates a user terminal (not shown), opens a browser of the user terminal and uses the browser to enter any of the video websites 2. The login here is not limited in logging into the video websites 2 through physical account and password.

Next, the system 1 obtains user information of the user from the DMP 4 according to a user ID of the user (step S52). In particular, the user ID is a browser ID of the browser used by the user terminal, but not limited thereto. By using the browser ID, the system 1 can request the DMP 4 for browsing history of the user in order to perform further analysis, or directly request the DMP 4 for the user information, such as the user's demography, interest, behavior, etc., which are analyzed by the DMP 4.

Next, the video website 2 receives a request from the user for displaying the video, and displays the requested video (step S54), and determines if the video is displayed to the advertising point selected by the advertiser at the above step S26 (step S56). If the video is not displayed to the advertising point yet, it keeps displaying the video regularly. If the video is displayed to the advertising point, the system 1 determines if the user is the target audience of the advertisement on the current advertising point according to the user information obtained from the DMP 4 (step S58), i.e., if the user satisfies the audience condition of the advertisement set by the advertiser at the above step S34.

If the system 1 determines that the user is not the target audience of the advertisement after the determination, the video is then displayed continually without displaying the advertisement on the advertising point. On the contrary, if the system determines that the user is the target audience of the advertisement, the system 1 will display the advertisement on the advertising point in the video (step S60). In the embodiment, the advertisement is the uploaded advertisement 7 uploaded by the advertiser at the above step S30.

After step S60, the system 1 determines if the video is displayed completely (step S62), and re-executes the step S54 to the step S62 before the video is displayed completely. Therefore, if the advertising right of multiple advertising points in the video are respectively belonging to different advertisers (i.e., they have different audience conditions for the target audiences), the system 1 can determine whether to display corresponding advertisements to the user or not on each of the advertising points respectively.

According to the present invention, the advertiser easily finds video frames which have high relativity to the advertisement to be advertised, and easily sets corresponding audience conditions for the advertised advertisement. Therefore, he or she can avoid displaying the advertisement to the users who are not interested in the advertisement, so as to save unnecessary advertising cost. Additionally, the present invention makes sure the content of the advertisement has high relativity to the frame(s) of the advertising point(s), so it's not unexpected or odd to the user watching the video and the advertisement. Also, if the user is determined as unsatisfactory for the audience condition set by the advertiser, the advertisement will not be displayed forcibly to the user, so the advertisement will be acceptable to the users who can see it on the advertising point of the video.

As the skilled person will appreciate, various changes and modifications can be made to the described embodiment. It is intended to include all such variations, modifications and equivalents which fall within the scope of the present invention, as defined in the accompanying claims.

What is claimed is:

1. A visible advertising system, comprising:
a target searching module, performing searching according to a searching keyword in order to obtain multiple frames of a video which have a target, wherein the searching keyword is corresponding to a label of the target;
an advertising point analyzing module, analyzing the multiple frames respectively in order to filter the multiple specific frames that is worth-to-advertise as multiple advertising points, wherein an amount of the advertising points is less than that of the obtained frames;
an advertisement setting module, selecting one of the advertising points, and uploading an advertisement and setting an advertising budget upon the selected advertising point;
a frame displaying module, displaying a corresponding frame of the selected advertising point;
a target audience setting module, setting an audience condition of a target audience of the advertisement; and
a real-time bidding module, performing a bidding action for the selected advertising point according to the advertising budget, and assigning the advertisement to the selected advertising point once the bidding action is winning.

2. The visible advertising system in claim 1, wherein the advertising point analyzing module is to analyze whether each of the frames is the specific frame that is worth-to-advertise according to at least one of background music information, background lighting atmosphere, appearance of leading role, and appearance time of the target of each of the frames.

3. The visible advertising system in claim 2, wherein the amount of the advertising points is less than ten.

4. The visible advertising system in claim 1, wherein the target searching module provides a searching column and a keyword recommending option on a searching page, the searching column receives an input of the searching keyword, and the keyword recommending option provides multiple keywords and receives a selection on each of the keywords to be as the searching keyword.

5. The visible advertising system in claim 1, wherein the frame displaying module, the advertising point analyzing module, the advertisement setting module and the target audience setting module respectively provide a frame displaying column, an advertising point listing column, an advertisement setting column and an audience setting column on an advertising page, wherein the frame displaying column displays a corresponding frame of the selected advertising point, the advertising point listing column displays the multiple advertising points of the video, the advertisement setting column receives an upload for the advertisement and a setting for the advertising budget, and the audience setting column receives a setting for the audience condition.

6. The visible advertising system in claim 5, wherein the frame displaying module configures an advertisement displaying area on the frame displaying column, and the advertisement displaying area displays the advertisement which is advertised on the advertising point.

7. The visible advertising system in claim 5, wherein the advertisement is a static image advertisement or a dynamic video advertisement, and the advertisement setting module further sets a length of time of the advertisement.

8. The visible advertising system in claim 7, wherein the advertisement setting module sets an advertising schedule of the advertisement, and the real-time bidding module calculates and displays a Cost per Mille (CPM) of the advertisement according to the advertising budget, the length of time and the advertising schedule.

9. The visible advertising system in claim 5, wherein the audience condition at least comprises an age and a gender of the target audience.

10. The visible advertising system in claim 5, further comprising an audience analyzing module, wherein the audience analyzing module analyzes a potential audience of the selected advertising point, and the audience analyzing module provides an audience analyzing column on the advertising page for displaying an age proportion and a gender proportion of the potential audience.

11. The visible advertising system in claim 5, wherein the label records a name and a type of the target, and also records at least one of appearance location, appearance time, appearance time duration, and frame proportion of the target in the video, wherein the searching keyword is corresponding to the name of the target, and the type of the target at least comprises an object type and a scene type.

12. A visible advertising method adopted by the visible advertising system in claim 1, comprising following steps of:
a) performing searching according to the searching keyword in order to obtain the multiple frames of the video which have the target, wherein the searching keyword is corresponding to the label of the target;
b) analyzing the multiple frames respectively in order to filter multiple specific frames that are worth-to-advertise as the multiple advertising points;
c) selecting one of the multiple advertising points and displaying a corresponding frame of the selected advertising point;
d) uploading the advertisement and setting the advertising budget;
e) setting the audience condition of the target audience of the advertisement; and
f) performing a bidding action for the selected advertising point according to the advertising budget and assigning the advertisement to the selected advertising point once the bidding action is winning.

13. The visible advertising method in claim 12, wherein the step b) is to analyze whether each of the frames is the specific frame that is worth-to-advertise according to at least one of background music information, background lighting atmosphere, appearance of leading role, and appearance time of the target of each of the frames.

14. The visible advertising method in claim 12, wherein the step c) is to display the corresponding frame of the selected advertising point on a frame displaying column of an advertising page; and the visible advertising method further comprises a step dl) of: displaying the uploaded advertisement on an advertisement displaying area of the frame displaying column after the step d).

15. The visible advertising method in claim 12, wherein the step e) is to set a age and a gender of the target audience of the advertisement.

16. The visible advertising method in claim 12, wherein the step d) further sets a length of time and an advertising schedule of the advertisement, and the visible advertising method further comprises a step f01) of: calculating and displaying a Cost per Mille (CPM) of the advertisement according to the advertising budget, the length of time and the advertising schedule before the step f).

17. The visible advertising method in claim 12, further comprising a step f02) of: displaying age proportion and gender proportion of a potential audience of the selected advertising point before the step f).

18. The visible advertising method in claim 12, wherein the label records the name and the type of the target, and also records at least one of appearance location, appearance time, appearance time duration, and frame proportion of the target in the video, the searching keyword is corresponding to the name of the target, and the type of the target at least comprises an object type and a scene type.

19. An advertisement displaying method adopted by the visible advertising system in claim 1, comprising following steps of:
a) accepting a user to login at a video web site;
b) obtaining user information from a data management platform (DMP) according to a user ID of the user;
c) receiving a request for displaying the video from the user;
d) determining whether the user is the target audience of the advertisement according to the user information when the video is displayed to the advertising point;
e) skipping displaying the advertisement on the advertising point if the user is determined as not the target audience of the advertisement;
f) displaying the advertisement on the advertising point if the user is determined as the target audience of the advertisement; and
g) re-executing the step d) to the step f) before the video is displayed completely.

20. The advertisement displaying method in claim 19, wherein the user ID is a browser ID of a browser used by a user terminal.
